(19) United States
(12) Patent Application Publication
(10) Pub. No.: US 2020/0364735 A1
(43) Pub. Date: Nov. 19, 2020

(54) Method to provide direct incentivization for data accuracy for distributed ledger-based reconciliation processes

(71) Applicant: Shayaan Khanna, New York, NY (US)

(72) Inventor: Shayaan Khanna, New York, NY (US)

(21) Appl. No.: 16/871,680

(22) Filed: May 11, 2020

Related U.S. Application Data
(60) Provisional application No. 62/848,557, filed on May 15, 2019.

(51) Int. Cl. G06Q 30/02; G06F 16/27; H04L 29/06; G06Q 10/10; G06Q 20/06; G06Q 20/36

(52) U.S. Cl. CPC G06Q 30/0215; G06F 16/27; H04L 63/0421; H04L 63/0428; G06Q 2220/00; G06Q 20/0655; G06Q 20/3678; G06Q 20/3676; G06Q 10/10

(57) ABSTRACT

A method to provide direct incentivization for data accuracy for distributed ledger-based reconciliation processes. The invention describes a method to quantify and potentially reward consensus between different parties storing data on a distributed ledger. The implementation of distributed ledgers enables a new class of business methods that enable and incentivize data accuracy at granular levels via distributed consensus.

### CROSS-REFERENCE TO RELATED APPLICATIONS

This is a cross-reference to the USPTO provisional patent with Application No. 62/848,557 filed May 15, 2019 by Shayaan Khanna titled “Providing direct incentivization for data accuracy for distributed ledger-based reconciliation processes”. This is the provisional patent I filed last year (sole inventor).

### FEDERALLY SPONSORED

Not Applicable

### JOINT RESEARCH AGREEMENT

Not Applicable since I am the Sole Inventor

### INCORPORATION-BY-REFERENCE OF MATERIAL SUBMITTED ON A COMPACT DISK

Not Applicable

### FIELD OF THE INVENTION

The present invention relates to distributed ledger-based data reconciliation with data accuracy incentivization.

### BACKGROUND OF THE INVENTION

Distributed ledgers or shared databases provide a means to record transactions and create a “golden source” based on a consensus of its participants. Existing business mechanisms may suffer from free-ridership where parties which consistently provide relatively inaccurate data may benefit from golden source data while contributing relatively less than their peers.

The problem addressed is reducing or eliminating free-ridership from parties (nodes) which all share data to create a consensus golden source. This is achieved by creating an incentivization system which would dynamically reward or penalize participants based on their relative data quality. This invention also provides a means for each party to perform external validation of each data point it possesses by seeing what fraction of other parties agree with its view.

This invention is a breakthrough in reconciliation practices. However, the practice of reconciliation itself has existed for decades. We observe a few examples of reconciliation in the financial sector alone, such as federal authorities reconciling regulatory data from banks, credit bureaus reconciling several inputs to create a credit score and banks reconciling counterparty reference data from multiple sources for securities trading. Each of these existing processes could be a potential use case for this invention. This invention has many potential future use cases within the Internet of Things (users' smart devices are rewarded for providing accurate weather data to a weather network), autonomous vehicles (vehicles communicating with each other via a decentralized network can be rewarded for providing other cars accurate traffic & terrain data) and third-party vendor management (the best data vendors are directly rewarded for their data accuracy).

This is also a breakthrough in current incentivization practices in the distributed ledger/blockchain field. This field has historically relied upon algorithms such as Proof of Work, Proof of Stake, Proof of Burn and Proof of Importance to achieve distributed consensus. However, none of the existing algorithms directly reward nodes based on the relative accuracy of the data itself in such a manner. This invention creates a transparent, and rules-based system to directly reward nodes on the accuracy of a data point relative to other nodes which share the same data point.

### RELATED ART

Not Applicable

### BRIEF SUMMARY OF THE INVENTION

The invention describes methods for incentivizing nodes that provide accurate data. In certain embodiments, a computerized network or distributed ledger communicates with one or more nodes which are used to create a shared golden source. This system may resemble a distributed ledger with independent nodes and a golden source dataset which is produced through a consensus-based reconciliation process involving those nodes. The inventor has recognized the need to incentivize data accuracy for datasets where one golden source does not naturally exist or is meant to be formed by a consensus of multiple parties.

If the consensus mechanism (such as simple majority) indicates that a node has provided correct data, then the node will either receive a full reward or split a reward (if there is more than one node determined to provide correct data) based on the incentive protocol. If the same consensus mechanism indicates that a node has provided incorrect data, then the node will be penalized or split a penalty (if there is more than one node determined to provide incorrect data). This process will be repeated for each record for every node in the network.

The key problem this invention addresses is free-ridership. It does so by creating a transparent, rules-based incentive protocol to dynamically reward nodes which provide correct data and penalize those which provide incorrect data. In various embodiments, this system can provide a scalable solution to entities and regulatory bodies which seek to constantly improve data accuracy across an entire system. It also imposes a direct economic cost upon entities with relatively poor data management programs or those who choose to deliberately misreport data externally (to retain some competitive advantage or to deliberately mislead other nodes). Other key benefits to parties include a golden source dataset for companies to make better decisions, a safeguard against deliberate manipulation of a single party's dataset, and a means for each party to externally validate its own data quality. More robust reconciliation practices may also reduce the incentive for counterparties to report fraudulent data to reporting parties in the first place, because reporting parties now have increased accountability. Regulators and other data aggregators would save both time and resources to reconcile reported data and can also judge the effectiveness of a company's data remediation plans.

The features described herein, or elements of such features can be combined to form additional useful and applicable embodiments. This summary is meant to be a brief overview of a selection of concepts which will be described in the detailed description below. The key elements and features of the invention will become apparent from the detailed descriptions, figures and illustrative examples.

### BRIEF DESCRIPTION OF THE DRAWINGS

The scope of the present disclosure is best understood from the detailed description below with reference to the following drawings. These drawings are meant to facilitate the reader's understanding of an example embodiment of this invention and are not meant to limit the breadth, scope or application of the system described.

FIG. 1. is a flow diagram illustrating an exemplary method to operate a system which creates a golden source dataset (“golden source”) and to incentivize data accuracy for a single reporting period.

FIG. 2A. illustrates exemplary datasets provided by each node which need to be reconciled in order to create the shared golden source.

FIG. 2B. illustrates an exemplary method for creating a golden source using a consensus mechanism.

FIG. 2C. illustrates an exemplary method for incentivizing nodes which provide correct data.

### DETAILED DESCRIPTION OF THE INVENTION

All the following descriptions and examples in this section (and the entire disclosure, at large) are for purposes of explanation and non-limitation.

### SCOPE OF THE INVENTION

Embodiments of the invention can be created by varying the below elements (Primary Key, Consensus Mechanism, Nature of Reward etc.). Each of these combinations is consistent with the principles of invention and is in scope for this disclosure.

Nodes: Each node on the network may represent a party such as a corporation, government entity, supranational entity, person or consortium. The nodes may have different viewership, editing, voting and other such rights. In one embodiment, the system has multiple peer nodes with write-access for each node's own dataset only. These nodes have read-access for each node's own dataset and also the final golden source dataset for records the node helps to reconcile. In certain embodiments, there may be a regulatory node without any write-access rights, but viewership rights over the entire final golden source dataset produced by the reconciliation process.

Network: In one embodiment, nodes are connected to one another on a distributed computerized network. The network used may be public, private or permissioned. This may be a new network or built on an existing network (public, private or permissioned). The network may be decentralized, or centralized. In a decentralized network, no single party (node or third-party) stores or manages the dataset, but the data is instead shared and synchronized across multiple sites and/or nodes. In a centralized network, the dataset may be stored or managed by a single node, combination of nodes, or a trusted third-party. The network may choose to employ side-chains or “layer” protocols (such as the Lightning Network Layer 2 protocol) built on top of the blockchain-based network. This network may be used to transmit data (e.g. during the reconciliation process). The same network may also be used to move value through fiat or token (e.g. during the incentivization process), or we may use a separate network.

Primary Key: The Primary Key to uniquely identify a single record may be a single identifier such as a Social Security Number (SSN) or a Legal Entity Identifier (LEI). The Primary Key may also be a combination of attributes that uniquely identifies a record, such as a concatenation of Social Security Number, Birth Date and Telephone Number.

Correctness of Data: Incorrect data is defined as data that does not reasonably reflect the current state of the record it describes. Reasons behind incorrect data include (but are not limited to) data that is incorrectly recorded during onboarding, not updated to reflect subsequent changes, improperly transformed or maliciously altered. An attribute that is expected to contain a non-null value but has a null value in a particular instance may be considered incorrect. For example, if Country of Domicile is blank for a banking client, the data may be considered incomplete and hence, incorrect.

Consensus Mechanism: Data is determined to be correct or incorrect by an “consensus mechanism”. The consensus mechanism can be as straightforward as a simple majority rule. For example, if 4 out of 5 nodes record that a client is domiciled in Singapore, and 1 node says the client is a domiciled in Malaysia, then the 4 nodes reporting Singapore are deemed “correct” and the 1 node reporting Malaysia is deemed “incorrect”. More sophisticated consensus mechanisms or algorithms may be applied given the limitations of this simply majority rule and to reflect the data management requirements of the situation. For instance, there may be a special rule for tiebreakers which may allow a regulatory node to step in and break the tie. As with any algorithm, this consensus mechanism may not reflect the actual reality. For example, 7 out of 8 nodes may show a particular client's Country of Domicile is Bhutan, 1 may say it's Colombia, but in reality, it's Iceland. This consensus mechanism and incentive protocol may be implemented either by a centralized party or automated via smart contract.

Incentive Protocol: The incentive protocol uses the validation results generated by the consensus mechanism as a major factor to determine rewards and penalties. In one embodiment the reward may be a direct financial reward, such as a fiat monetary award each reporting period or a reduction in fees. In another embodiment the reward may be an indirect financial reward such as incentive points, or a blockchain's own native token which can be redeemed for future benefits. The inventor recognizes that the reward may have nonmonetary embodiments such as a quantitative metrics which regulators can use as a benchmark to determine future fines for data control deficiencies. Regulators may also use these quantitative metrics to benchmark whether data remediation programs are truly effective. For example, financial regulators may reprimand and fine banks for ineffective AML (Anti-Money Laundering) procedures and use these quantitative metrics to track the progress of a bank's remediation plan to address those deficiencies.

Reward Weighting by Node: In certain embodiments, each node is expected to have an equal level of data accuracy. In other embodiments, one node is held to a higher standard than others. The node with the higher standard is therefore given a smaller reward and/or a larger penalty during the reconciliation process. For example, one of the largest banks in the country may be held to a higher standard than a small, community bank by the federal regulators.

Reward Weighting by Attribute: In the simplest embodiment, each attribute is given the same level of importance. In another embodiment, the reward or penalty is assessed by the importance of the attribute or the importance of achieving consensus on that attribute. This is achieved by relative weighting of the reward and penalty parameters for each specific attribute. For example, if a bank is concerned about AML/KYC (Know Your Customer), the Country of Citizenship and Occupation attributes may not be equally as important to a bank. For example, it's likely more important for a bank to check whether a client is from an OFAC (Office of Foreign Assets Control) sanctions country list rather than whether they are a doctor/lawyer. Therefore, the per-data-point reward/penalty for Country of Citizenship may be greater than or smaller than the value for Occupation. In another embodiment, some attributes may be completely out of scope for reconciliation, such as loan exposure amount. Therefore, they will be assigned zero weighting, and will not be in scope for reconciliation. For example, a client may have a $100,000 loan with one bank, and $2,000 in credit card debt with another bank. These attributes (product type, loan exposure amount) may not be in scope for reconciliation, since clients may have different products & exposures with different banks. The client's reference data (such as Country of Domicile, Primary Address) are likely good candidates to be in scope for the reconciliation process and would likely be similar/identical across all banks. Such attributes will be referred to “in-scope attributes” from now on.

Sum of Rewards and Penalties: In one embodiment, the sum of all the rewards (across all nodes) equals the sum of all the penalties (across all nodes). Hence the system as a whole is zero sum, though each individual node may receive a reward or penalty at the end of the reporting cycle. In another embodiment, the sum of rewards and penalties can be net positive or negative and is fixed by a centralized or authority. In another embodiment, the sum of rewards and penalties can be dynamic and dependent on factors including (but not limited to) the extent of agreement/disagreement during the current reconciliation cycle, the overall reconciliation performance of the previous cycle(s), or the number of records being reconciled.

Identity of Contributors: In one embodiment, the identity of the approving parties can be public to all institutions that participate in reconciling a particular record. For example, Node J may have data for a record that disagrees with what Nodes K, L and M report for the same record. Node J would then know that it does not have a consensus view and know the exact identity of the entities which disagree with it for that particular record (i.e. Nodes K, L and M). In other embodiments, the blockchain may implement anonymization techniques including (but not limited to) Zero-Knowledge Proofs or Ring Signatures such that the identity of the node/party which has participated in reconciling that attribute for that particular record remains unknown. For example, Node S knows a certain attribute for a particular record disagrees with 3 out of 4 nodes but does not know the exact identity of the node/party it disagrees with. Either of these two exemplary embodiments would be extremely useful for validating a bank's customer reference dataset. For example, it would now be possible for a bank to know that 9 out of 10 of its peer institutions believe a customer lives in Philadelphia, but its own records show the customer lives in Madison. The bank could check its own records versus other third-party reference data, request the client for more recent documentation, invest in strategic data quality programs or pursue other alternatives to improve its own data quality.

Golden Source Data Viewing Rights: In one embodiment, a node can view the final golden source dataset for any records it participates in the reconciliation process for. Each node whose data was deemed incorrect will get to see what the consensus value of the attribute was determined to be in the golden data source. In another embodiment, the node would only be informed whether its own data was deemed correct or incorrect by the system. In the case where it's incorrect, it is not informed what the consensus value in the golden data source is. For example, if Node J believes the record's Country of Domicile is Brazil, but the consensus value in the golden source dataset is South Korea, Node J is simply informed that its answer does not match the golden source but is not informed that the golden source reported South Korea.

Features and aspects may be implemented in the embodiment described below, which the inventor believes would be very useful for reconciling and regulating reference data in the financial sector.

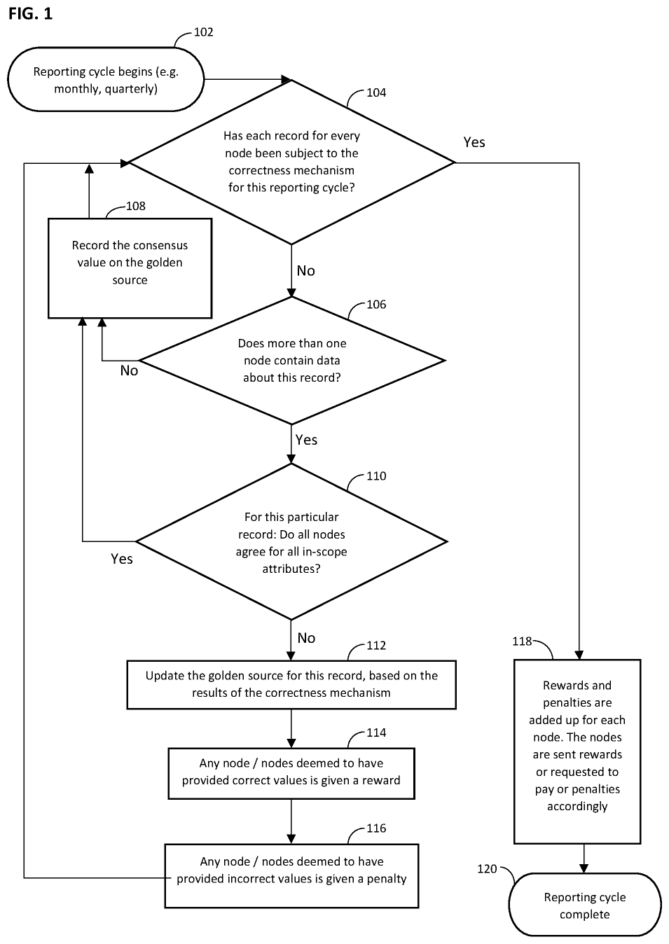

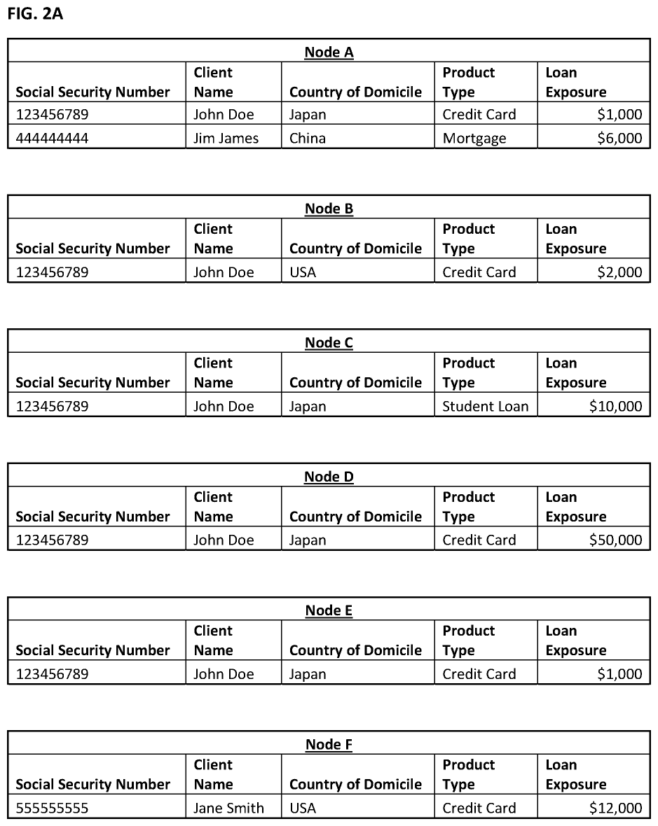

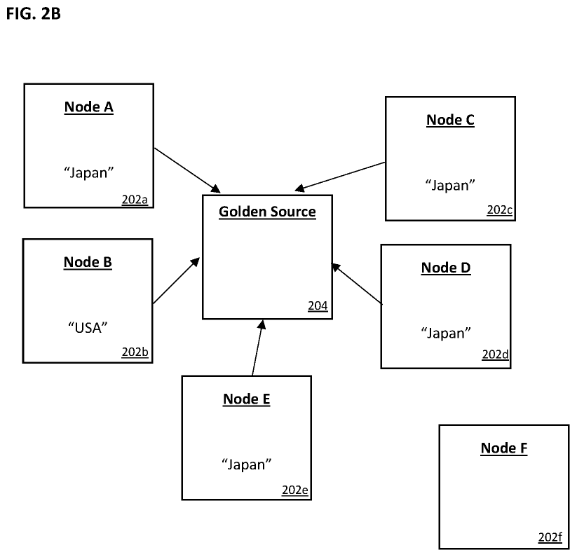

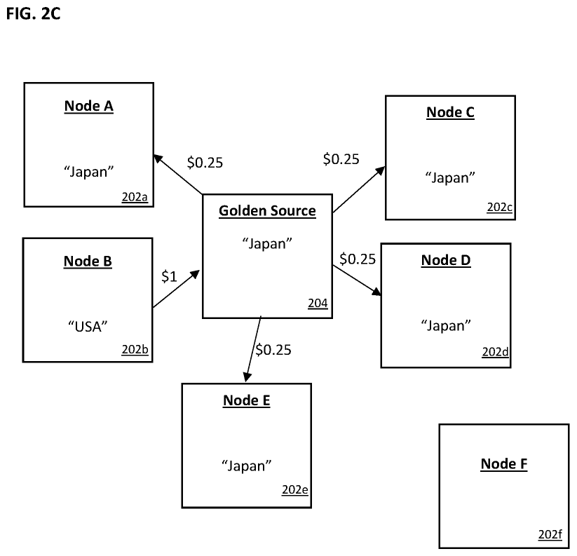

FIGS. 1, 2A, 2B and 2C illustrate an example of a specific embodiment of the system in a financial reconciliation process. This example is highly simplified and is meant to help the reader understand a specific use case of the invention and is not meant to limit the breadth, scope of application of this disclosure.

In this exemplary embodiment, each node is a regulated bank with read-access and write-access on its own dataset. The regulated banks can also view the final golden source dataset for records for which it participates in the reconciliation process. A regulatory node (such as the SEC or the Federal Reserve) will have read-access for the entire final golden source dataset produced by the reconciliation process. The network in this example is a distributed network which moves both data and fiat currency. This would be a permissioned network, and the regulatory node would determine which parties can participate in the system and their associated rights. The Primary Key is the Social Security Number. Data is deemed to be incorrect if it does not accurately reflect the current state of the record it describes. The consensus mechanism is a simple majority, where each bank/node has an equal vote. The nature of the reward is a fiat monetary award. Each node is given equal rewards or punishments for being correct or incorrect respectively. This is because our example relates to banks who are peer institutions and have equal responsibility to report accurate data to regulators. The only attribute being reconciled is Country of Domicile. The Country of Domicile attribute is the only attribute being reconciled in this example, so the question around weighting of this attribute versus others does not arise. The sum of all the rewards would equal the sum of all the penalties (making the overall system zero sum). The identity of the contributors is unknown, so a bank only knows (for example) that 12 of its 14 peers disagree with them over a particular data point, but not who any of those institutions are. The bank will be able to see the golden source for attribute it's participated in the reconciliation process for. This would enable it to see where its own discrepancies are relative to the consensus value for a particular record and in-scope attribute.

FIG. 1. is a flow diagram illustrating an exemplary method to operate a system which creates a golden source dataset and to incentivize data accuracy for a single reporting period.

At Step 102, we begin the cycle for a single reporting time period. The reporting cycle frequency could be real-time, daily, weekly, monthly, quarterly, ad hoc or other relevant & reasonable frequencies.

At Step 104, we go record by record row-wise for each of the nodes and ensure that we capture every record. If there are still records to be checked by the consensus mechanism, we move to Step 106. However, if every record of every node has been subject to the consensus mechanism for the reporting cycle, we move to Step 118.

At Step 106, we check whether there is more than one node which contains data about a particular record. This can be thought of as a client/record which does business with more than one bank/node. If only one node reports on a particular record, then the consensus mechanism indicates an automatic majority. We move to Step 108 and directly update the golden source with that one node's values for that particular record. We then move to Step 104. For example, if Node R is the only entity reporting data for Social Security Number 777777777 and lists Country of Domicile as Thailand, then the golden source would report the Country of Domicile as Thailand. The reconciliation and incentivization process would be skipped since there's no other data to reconcile against. However, if more than one node reports on a particular record, we move to Step 110.

At Step 110, we go attribute by attribute column-wise for all in-scope attributes for that particular record. If all the nodes report identical data for all the in-scope attributes, then the consensus mechanism indicates a unanimous majority since all parties agree on all in-scope attributes for that record. We move to Step 108, where we directly update the golden source with the consensus values for that particular record. We then move to Step 104. For example, if all nodes that report data for Social Security Number 111111111 agree that the Country of Domicile is France, then the golden source would report Country of Domicile as France. The incentivization process would be skipped since all nodes agree on all in-scope attributes for that particular record. However, if even a single node has different data from the other nodes for a single in-scope attribute for a particular record, we move to Step 112. Each node subject to Step 112 will be referred to in this disclosure as a “participating node” going forward.

At Step 112, we apply our consensus mechanism across all participating nodes for all in-scope attributes to reconcile the data and create the golden source.

At Steps 114 and 116, we apply rewards and penalties via the incentive protocol to the participating nodes and then move to Step 104.

At Step 118, we add up all the rewards and penalties the nodes have accrued over the reporting period. We then apply the rewards and penalties to all nodes and ensure that the net rewards or penalties are distributed to all nodes.

At Step 120, the process is complete for one reporting cycle.

FIG. 2A illustrates exemplary datasets provided by (and owned by) each node which are reconciled in order to create the golden source dataset. Nodes A, B, C, D, E and F each represents distinct, regulated banks. Each bank collects reference data from clients including Social Security Number, Client Name and Country of Domicile. The bank then extends loan products to the clients with various exposure amounts (e.g. $1,500 on a credit card and $30,000 on a personal loan). The in-scope attribute in this example is Country of Domicile only. In this example, there is only one record (Social Security Number 123456789) which does business with more than one bank. Nodes A, B, C, D and E are the participating nodes for the record with Social Security Number 123456789. Records with Social Security Numbers 444444444 and 555555555 cannot be reconciled since only one bank (node) does business with them so there's no other bank (node) to reconcile them with.

FIGS. 2B and 2C illustrate an exemplary method for creating a golden source dataset using a simple majority consensus mechanism and incentivizing nodes which provide correct data. We are comparing the Country of Domicile since it's the only in-scope attribute. FIGS. 2B and 2C represent the reconciliation process for a single client only (Social Security Number 123456789).

For FIG. 2B, Nodes A, B, C, D, E and F are represented on the diagram as 202a-202f. The golden source distributed ledger is represented by 204. The arrows represent flow of data from the participating Nodes 202a-202e to create the golden source 204. Note that Node F 202f does not participate in the golden source creation process or the incentivization process for this client (Social Security Number 123456789) since Node F 202f does not report doing business with the client. Node F 202f would also not see the golden source dataset for the client (Social Security Number 123456789). We observe that Node B 202b believes the client has a Country of Domicile of “USA”, whereas Node A 202a, Node C 202c, Node D 202d and Node E 202e believe the client has a Country of Domicile of “Japan”. The golden source 204 is determined by a simple majority consensus mechanism. 4 out of 5 nodes agree on Japan, so Japan is stored in the golden source 204. Participating Nodes A to E 202a-202e are notified that Japan is the value chosen by the consensus mechanism because 4 out of 5 nodes agree (without disclosing the exact identity of the nodes that agreed/did not agree).

For FIG. 2C, we use labels 202a-202f and 204 to represent the same nodes and golden source distributed ledger as in FIG. 2B. FIG. 2C shows the flow of rewards/penalties to the participating nodes for the same record we reconciled in FIG. 2B (Social Security Number 123456789). In our example, the “reward” for correct data for each record is $1. Therefore $1 is split equally between all four nodes determined to have provided correct data per the consensus mechanism. In this case, Node A 202a, Node C 202c, Node D 202d and Node E 202e provide correct data so each node gets a reward of $0.25. In our example we assess the penalty as being equal to the reward ($1). Since only Node B 202b has incorrect data, so that node is given the entire penalty of $1. Note that Node F 202f does not receive any reward or penalty since it does not participate in golden source creation for Social Security Number 123456789. Arrows pointing from the golden source 204 to Node A 202a, Node C 202c, Node D 202d and Node E 202e represent the $0.25 rewards. Arrows pointing from the Node B 202b to the golden source 204 represent the $1 penalty. The golden source 204 reflects Japan as the Country of Domicile for the record once the reconciliation and incentivization processes are complete. After the golden source 204 is updated and the reward/penalty is distributed across all participating nodes, the process is complete for that record.

It is to be understood that the above described embodiments are merely examples of numerous and varied other embodiments which may constitute applications of the principles of the invention. Those skilled in the art may apply various modifications, alterations and adaptations to this invention's embodiments to derive some or all of the advantages or inventive concepts of the present invention. This patent applies not only to the embodiments shown herein, but the widest scope consistent with the principles and novel features disclosed herein.

What is claimed is:

1. A method to incentivize data accuracy on a computerized network or a distributed ledger comprising:
connecting one or more nodes on the computerized network or distributed ledger;
transmitting data from these nodes to a known location on one or more servers;
aggregating data from the individual nodes and identifying which node is the source of the data;
comparing the aggregated data received from the nodes;
generating a consensus dataset and validation results via a consensus mechanism which is driven by data accuracy;
creating an incentive protocol based on the data accuracy validation results; and
presenting data such as the aggregate consensus dataset or validation results to at least one end-user.

2. The method of claim 1, wherein the computerized networked is a permissioned distributed ledger or permissioned blockchain.

3. The method of claim 1, wherein the consensus mechanism is stored on the distributed ledger or computerized network.

4. The method of claim 1, wherein the incentive algorithm is stored on the distributed ledger or computerized network.

5. The method of claim 1, wherein the data is encrypted and/or anonymized by the nodes before being transmitted to the distributed ledger.

6. The method of claim 1, wherein the consensus mechanism is executed via a smart contract.

7. The method of claim 1, wherein the incentive protocol is executed via a smart contract.

8. The method of claim 1 wherein data such as the consensus dataset or metrics from the consensus dataset is transmitted back to the participating nodes.

9. The method of claim 1, wherein the individual nodes include:
a corporate data storage system;
a federal data storage system;
a personal computer;
a vehicular computer;
an IoT computing device;
a mobile computing device;
a physical or virtual payment device; or
a decentralized autonomous organization storage system.

10. The method of claim 1, wherein the incentive protocol reward or penalty is distributed via an electronic currency such as a public cryptocurrency, a private cryptocurrency or the ledger's native cryptocurrency.

11. The method of claim 1, wherein the either or all of the identity of the individual nodes, consensus dataset or validation results are revealed to participants in the network or external third parties.

12. The method of claim 1, wherein the incentive protocol is generated using several factors which include those other than the accuracy of the data provided by the participating nodes.

13. The method of claim 1, wherein the consensus dataset and validation results are stored in the distributed ledger as a transaction.

14. The method of claim 13, wherein select transactions or the aggregate state of the entire distributed ledger are broadcast to parties including network participants and/or third-parties.
